(19) United States
(12) Patent Application Publication
(10) Pub. No.: US 2007/0192785 A1
(43) Pub. Date: Aug. 16, 2007

(54) Two-way PDA, laptop and cell phone audience response system

(75) Inventors: Martin Pellinat, San Diego, CA (US); Adam Hawkins, San Diego, CA (US); Alan Da Costa, San Diego, CA (US)

Correspondence Address: HOGAN & HARTSON L.L.P., 1999 AVENUE OF THE STARS, SUITE 1400, LOS ANGELES, CA, 90067, US

(73) Assignee: Vision Tree Software, Inc.

(21) Appl. No.: 11/498,430

(22) Filed: Aug. 2, 2006

Related U.S. Application Data
(60) Provisional application No. 60/772,270, filed on Feb. 10, 2006.
(60) Provisional application No. 60/775,694, filed on Feb. 21, 2006.

(51) Int. Cl. H04N 7/18; H04N 7/16; H04N 7/173

(52) U.S. Cl. 725/24; 725/62; 725/81; 725/100

(57) ABSTRACT

A two-way PDA, cell phone and laptop audience participation system providing the ability for real-time audience participation in questions and surveys and for real-time generation and display of results. A plurality of two-way wireless communication devices such as PDAs, cellphones or laptops are provided for use by participants at an event. At least one two-way wireless communication device, such as a wireless tablet, is provided for use by a presenter. Communications are between the presenter and participants are managed by a central server, wireless access points and routers.

### RELATED APPLICATIONS

This application claims the benefit of U.S. provisional application Ser. No. 60/772,270, filed on Feb. 10, 2006, and U.S. provisional application Ser. No. 60/775,694, filed on Feb. 21, 2006.

### BACKGROUND OF THE INVENTION

1. Field of the Invention

This invention relates to audience response systems and, more particularly, to an interactive, two-way PDA, laptop and cell phone audience response system.

2. Description of Related Art

The current marketplace has established that audience response systems for small and large group meetings and conferences have been a beneficial way for participants to interact with presenters. Typically, such systems employ radio frequency (RF) based devices to allow participants to reply to multiple choice questions with a selection of one of the displayed multiple choice answers (i.e. A, B, C, D, etc.).

Audience response systems of this type suffer from many limitations. Known audience response systems provide one-way communication only and do not allow real-time two-way exchange of free flowing ideas or updated questions to be answered. In addition, it typically takes 10-15 seconds for participant answers to be received in known RF systems. This is an antiquated technology and there is currently no known solution to meet the expectations of today's fast paced real-time communication society.

### SUMMARY OF THE INVENTION

The present invention provides a state-of-the-art, wireless, two-way data driven PDA, laptop and cell phone audience participation system. It has widespread application including events such as interactive scientific meetings, corporate and professional conferences and events, organizational and leadership retreats, healthcare, legal and other professional societies, and the like.

One embodiment of the invention is an audience participation system comprising a plurality of participant two-way communication devices and at least one presenter two-way communication device. A central server and wireless LAN manage communications between the participant and presenter devices, and the system provides real-time audience participation and real-time generation and display of results.

Another embodiment of the invention is an audience participation system comprising a plurality of participant two-way communication devices such as PDAs, laptops and cellphones. The participant devices have means for displaying surveys and questions, means for collecting survey results and answers to the questions from participants, means for communicating the survey results and answers, means for collecting questions from participants and means for communicating the questions. The audience participation system also includes at least one presenter two-way communication device. The presenter device has means for receiving the survey results and answers from the participant devices, means for aggregating and displaying the results and answers in real time and means for receiving the questions from the participant devices and displaying the questions in real time. A central server and wireless LAN manage communications between the participant and presenter devices.

Another embodiment of the invention is a method for facilitating participation in an event having a plurality of participants and a presenter. Participant and presenter two-way communication devices are provided that are custom-configured for the event. Questions and surveys are sent to the participant devices. Answers to the questions and survey results are obtained from the participant devices and sent to the presenter device. Questions are also obtained from the participant devices and sent to the presenter device. The answers and survey results are aggregated and displayed in real time with the presenter device. The questions from the participant devices are also displayed in real time with the presenter device.

Other features and advantages of the invention will be apparent from the following detailed description, taken in conjunction with the accompanying drawings which illustrate various features of embodiments of the invention.

### BRIEF DESCRIPTION OF THE DRAWINGS

FIG. 1 is a perspective view of an exemplary conference room environment in which the system of the present invention may be deployed.

FIG. 2A is a front view of a PDA according to the present invention with a home page display.

FIG. 2B is a front view of a PDA according to the present invention with a survey page display.

FIG. 2C is a front view of a PDA according to the present invention with a question page display.

FIG. 3 is a block diagram showing exemplary wireless coverage and access points in a conference room provided by the system of the present invention.

FIG. 4 is a block diagram of one implementation of a two way audience participation system according to the present invention.

FIG. 5 is a screen shot of an exemplary “viewer's page” according to the present invention.

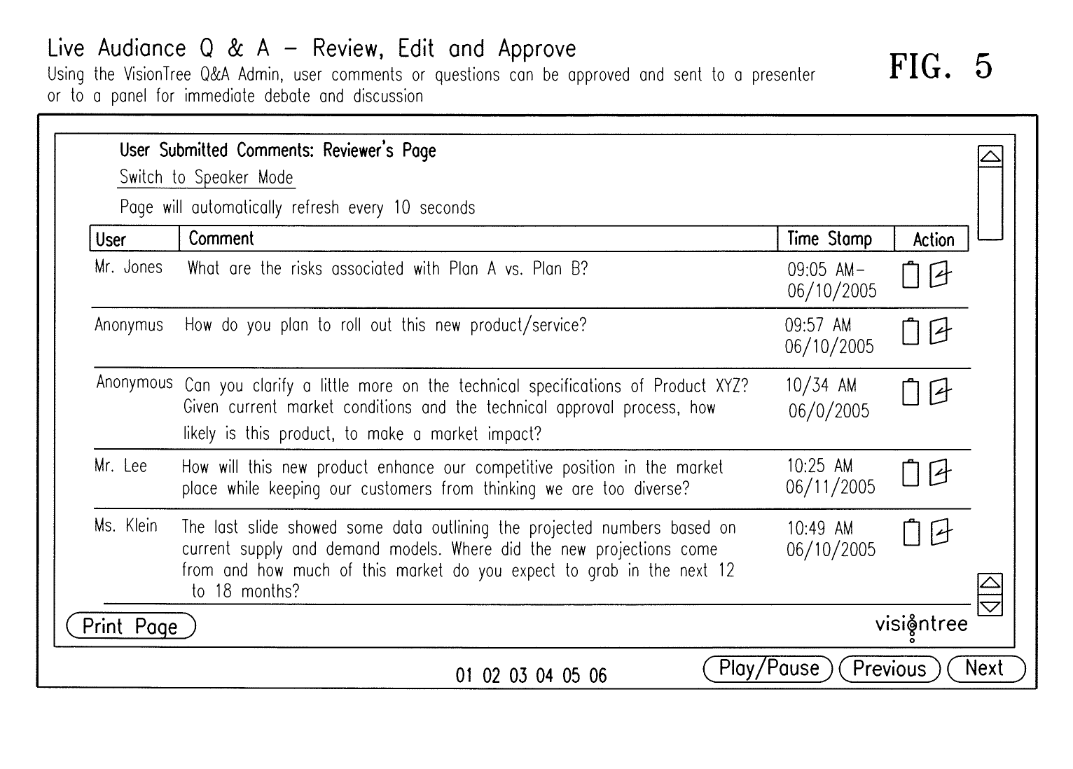

FIG. 6 is a screen shot showing exemplary survey questions sent from the presenter to participants.

FIG. 7 is a screen shot showing an exemplary display of real-time audience results.

FIG. 8 is a block diagram illustrating hardware components of a two way audience participation system according to the present invention.

FIG. 9 is a block diagram illustrating a system for preventing data flow interruption according to the present invention

### DETAILED DESCRIPTION OF THE INVENTION

The present invention provides a state-of-the-art, wireless, two-way data driven PDA, laptop and cell phone audience participation system. Each audience participant receives a custom-configured two-way communication device such as a PDA, laptop or cell phone. Devices employing combinations of these technologies, such as a cell phone with an integrated PDA, may also be used. It should also be understood that other two-way communication devices, in addition to PDAs, laptops and cell phones, may also be utilized and are within the scope of this invention.

In one embodiment of the invention, the conference room is configured with a local area network (LAN) wireless router system, as will be described in more detail below. The participant PDAs or laptops send a signal with their IP address via the router system to a server. Software on the server runs a thin client application for each participant enabling the participants to engage in interactive activities such as submission of questions, taking surveys and tests, sending and receiving messages and viewing data (e.g. PowerPoint presentations, charts, etc.).

In another embodiment of the invention, a user may access the system using a cell phone or wireless handset. A web browser integrated in the cell phone may access the system via the Internet and/or a locally-based WiFi network. Additionally, a user may send an SMS (Short Message Service) to a designated number with their question or survey response. This SMS is integrated into the system's database through an XML feed and displayed with all survey, poll and question data from the other devices (i.e. PDA, laptop). Thus, a participant may engage in full functionality of the application using an existing cell phone network (i.e. cell towers and 3G or 1xRTT technology provided by a wireless carrier) or WiFi network. In the case of WiFi, the user's cell phone would also need a built-in or external WiFi card.

Thus, in one embodiment, where all users access the system with cell phones, existing communications infrastructure may be relied on and the auditorium need not be equipped with a wireless LAN and routers. Another embodiment may combine a local network with existing infrastructure. That is, some users may access the system using cell phones and existing cellphone/Internet infrastructure, whereas other users may access the network utilizing PDAs/laptops and the conference room-configured LAN.

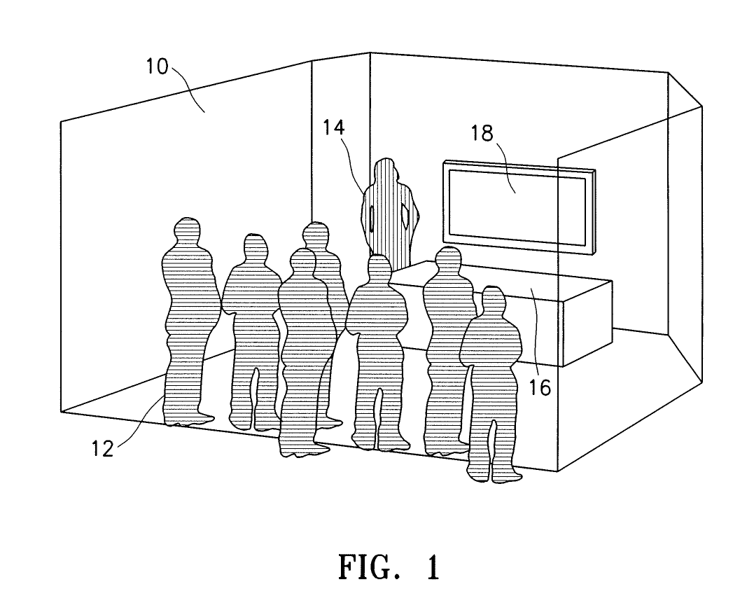

FIG. 1 is a general depiction of an environment in which the system of the present invention may be deployed. The two-way audience participation system will typically be deployed in a conference room 10 or other suitable space. Typically present in room 10 will be a plurality of participants or audience members 12 and one or more presenters 14. Presenter 14 will typically have a table 16 (or lectern, podium, etc.) as well as some display device 18 such as a projection or TV screen.

Each participant or audience member 12 is provided with a two-way communication device 20 to enable participants 12 to participate and interactively engage in the conference. Devices 20 may be easily checked-in and -out from a handheld station(s). The mobility and small form of a PDA makes it ideal for use as device 20. Typically, no prior user training is required, however, a small instruction sheet or quick guide describing use of the system may be provided. It should be appreciated, of course, that other communication devices such as laptop computers, cell phones and the like could alternatively be utilized. For ease of discussion, the description below refers primarily to “PDAs”, however, it should be understood that another two-way communication device such as a laptop or cell phone could be substituted for the term “PDA”.

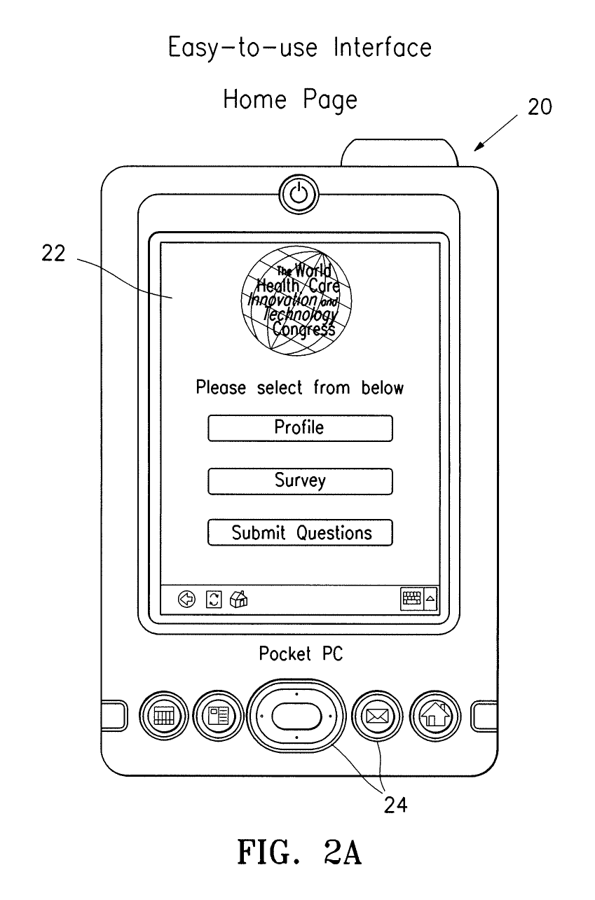

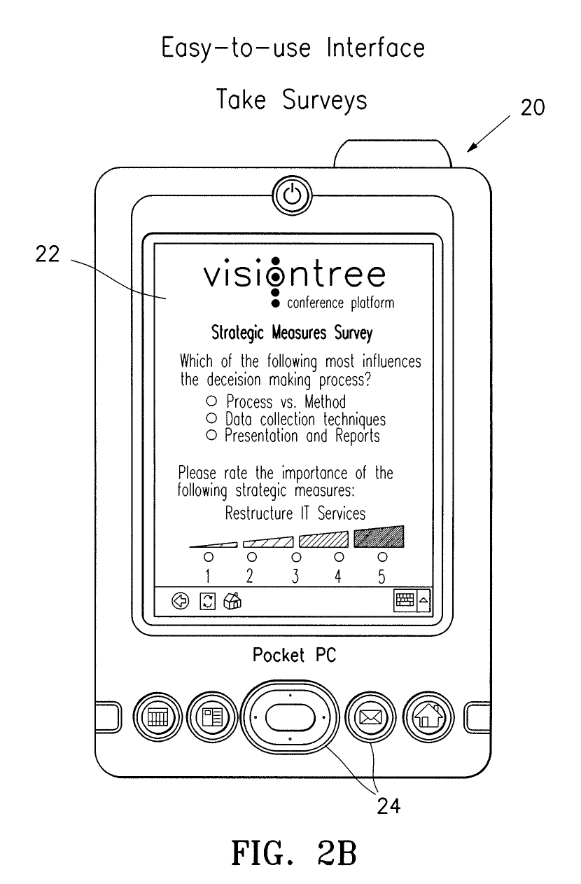

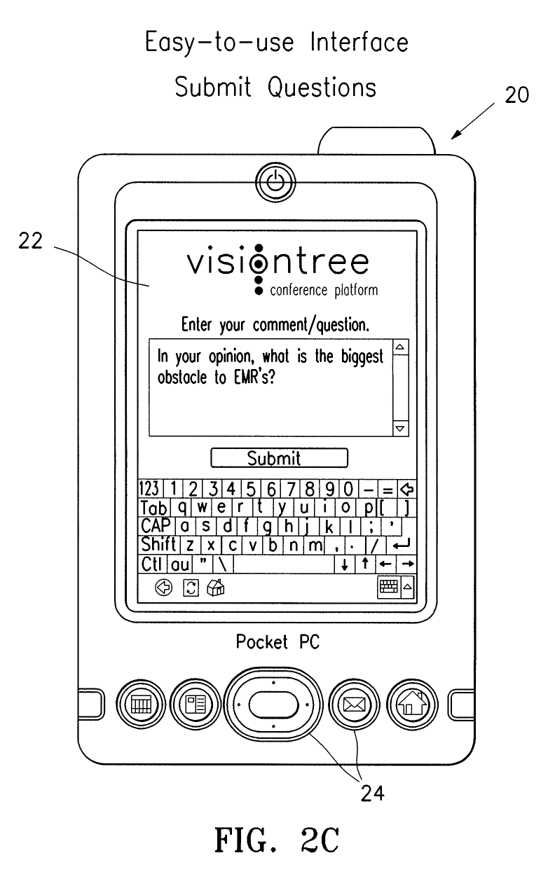

FIGS. 2A-C illustrate a custom-configured PDA 20 according to the present invention. PDA 20 includes a touch sensitive display screen 22 and user input and navigation buttons 24 that are operable by finger/pen or scrollable thumb navigation. As shown in FIGS. 2A-C, various displays may be presented on display screen 22 such as, for example, a home page (FIG. 2A), a survey page (FIG. 2B), and a question page (FIG. 2C). These are merely exemplary displays; as will be described below, virtually limitless displays are possible.

PDA 20 is advantageously branded and/or custom-configured for the particular conference, meeting or event that is taking place. Conference sponsor ad placement may be displayed or physically provided on the device. PDA 20 has wireless communication capability and permits two-way communication between participants 12 and presenter 14 (or support personnel). Display screen 22 is preferably a full touch, color screen and user input buttons 24 provide unlimited text input options. PDA 20 can accept a large number of question and survey styles and types (i.e, 20 or more). This represents a vast improvement over RF handsets that are traditionally used in a conference or meeting environment to facilitate audience participation. Traditional RF handsets used for this purpose typically do not have a display screen, have no means to accept free form text input and can only except limited question types.

PDA 20 preferably has onboard memory for fast processing and storage of presentation materials and ads, for example. A media slot may also be provided for additional storage/processing capability. An internal backup battery, or a swappable battery, may be provided for long events, and PDA 20 also preferably implements power saving features to extend battery life. PDA 20 is provided with USB syncing capability for easy set up.

In one embodiment, PDA 20 has a Windows® based operating system as well as Microsoft® Word®, Outlook®, PowerPoint®, Excel® and Internet Explorer® functionality. PDA 20 will typically include a Macromedia® Flash® player for Flash® applications, Kiosk® software for fail-safe functionality and Bluetooth® profile exchange functionality. In one particular implementation, a PDA having the following technical specifications was used: Intel® XScale processor with WMMX; 3.5 inch QVGA TFT, touch sensitive display; integrated 802.11a/b wireless technology; Bluetooth® technology; secure digital (SD) multimedia card slot; 0.59″ thickness and 4.9 oz weight; extended 1600 mAh battery; and Microsoft® Windows® Mobile 2003 SE. It must be appreciated, of course, that this is only one exemplary embodiment and that any other device having suitable input, display and two-way communication capability could be employed in the system of the present invention.

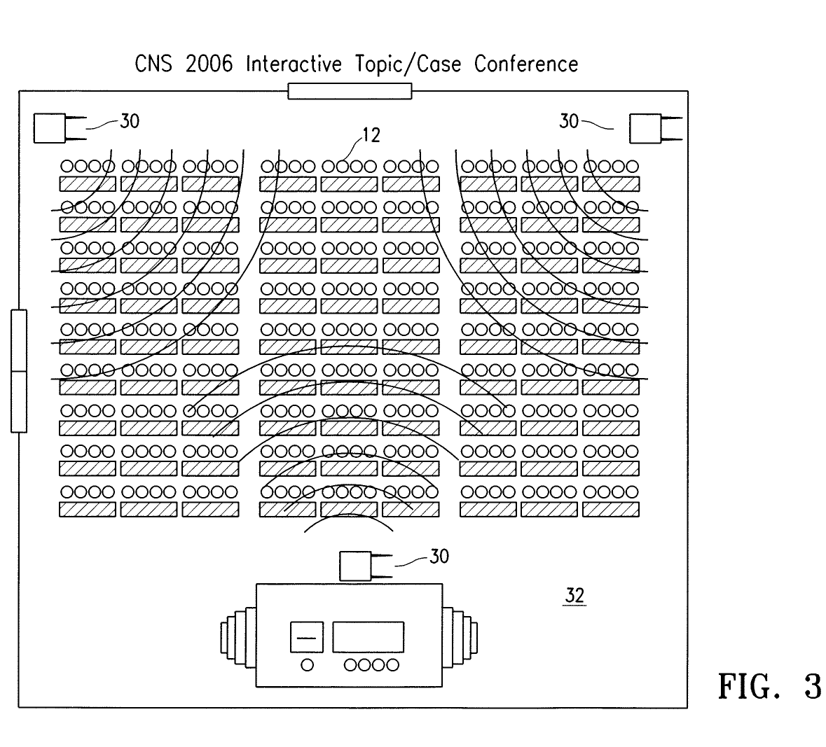

Participants 12, using their PDAs (or other communication device) 20, are able to join and participate in sessions via a wireless communication system. As illustrated in FIG. 3, a plurality of wireless access points 30 may be provided to provide wireless LAN access to a group or meeting room 32 of any size or configuration. Participants 12, having been outfitted with a PDA or other two-way communication device 20, may join and participate in sessions at any time, and seamless, real-time interaction between audience 12 and presenters 14 is facilitated. In one exemplary embodiment, a Cisco® Aironet® wireless system is utilized to provide the wireless access.

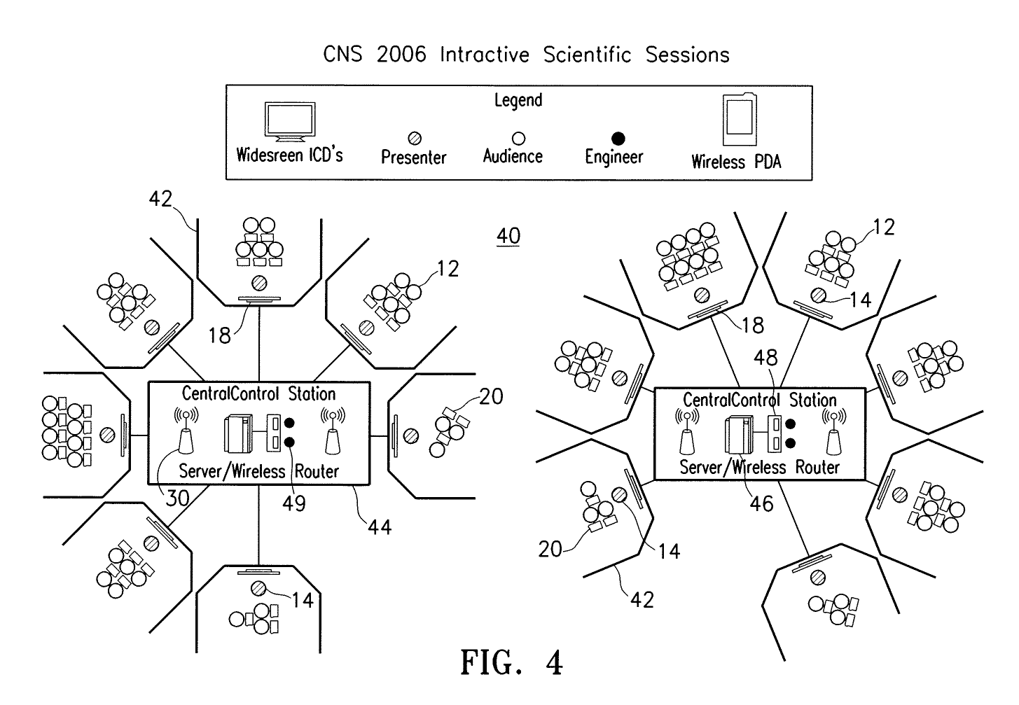

FIG. 4 is a block diagram of one implementation of a two way audience participation system 40 according to the present invention. As illustrated, system 40 may be deployed in a conference center or facility having a plurality of conference rooms or spaces 42. As previously described, each conference room 42 is configured to accommodate a plurality of participants or audience members 12 and presenters 14. Audience members 12 are provided with two-way communication devices such as PDAs 20. Presenters 14 typically have access to a display screen 18, such as a TV, computer or other projection display.

As described with reference to FIG. 3, wireless access points 30 are deployed throughout the plurality of rooms 42 to provide wireless interactivity to each participant 12 via their PDA 20. System 40 includes one or more central control stations 44. Control stations 44 coordinate and control the two-way interactive sessions in one or more conference rooms 42. As depicted in FIG. 4, two control stations 44 are provided, each responsible for seven conference rooms. However, it should be understood that these numbers are completely arbitrary and for sake of illustration only. For instance, there could be just one conference room 42 under the control of one central station 44. The present invention can be adapted to meet the needs of any size and configuration of a conference, meeting or other event.

Each control station 44 includes a central server 46 in communication with wireless access points 30, and hence audience PDAs 20, via wireless routers 48. In addition, central server 46 is in wired or wireless communication with a two-way communication device utilized by presenter 14. Thus, presenter 14 will also have their own laptop, PDA, cellphone or computer for two-way communication. A wireless tablet PC is particularly suitable due to ease of use and navigation in a presentation setting. In this manner, central server 46 facilitates and coordinates two-way communication between presenter 14 and participants 12. Support personnel or engineers 49 will typically be present in control station 40 to oversee the proper operation of system 40.

The components of system 40, including server 46 and PDAs 20, preferably have high bandwidth capabilities to support large numbers of users and data, as well as streaming video capabilities for demos and presentations.

System 40 provides an unmatched level of interactivity and participation between participants 12 and presenters 14. Participants 12 may individually take surveys and tests during the course of the event. Participants 12 may engage in live “Q&A” by submitting real-time questions to presenter 14 (or a panel, a moderator, etc.) utilizing their communication device (PDA or laptop) 20. These questions may be answered in real time by presenter 14, or could be answered later, for example, by collecting the participant's email address and sending them an email with an answer or a link to useful materials. Participants can view a dynamic event schedule and can access documents or media (i.e. conference and sponsor materials) in real time via a link accessible by their device 20.

Attendance at the event may be easily tracked and recorded. Thus, professional accreditation (e.g. CME/CEU/CE/CLE) can be easily provided by system 40 by recording attendance and/or providing knowledge retention tests. Individual as well as group performance results may be tracked and displayed.

System 40 may also provide a silent auction feature allowing both participants 12 and presenters 14 to bid on items. Bid date/time stamping may be provided for real-time, two-way bid acceptance and communication to the audience of the bidding process. Similarly, locally based e-commerce applications may be provided. For example, participants may have the ability to buy books, podcasts, etc. that are related to the conference or meeting. In a similar vein, a follow up email may be sent to participants including products of interest for purchase.

Participants may choose to operate in either profile (with ID) or anonymous mode. A profile survey may be conducted on initial login. Thus, participants may anonymously participate or submit questions. Participants 12 can identify the profile and location of other participants at the event matching their profile by utilizing location networking and profile exchange via the wireless router system (or Bluetooth®). System 40 can support a business card exchange or other networking package.

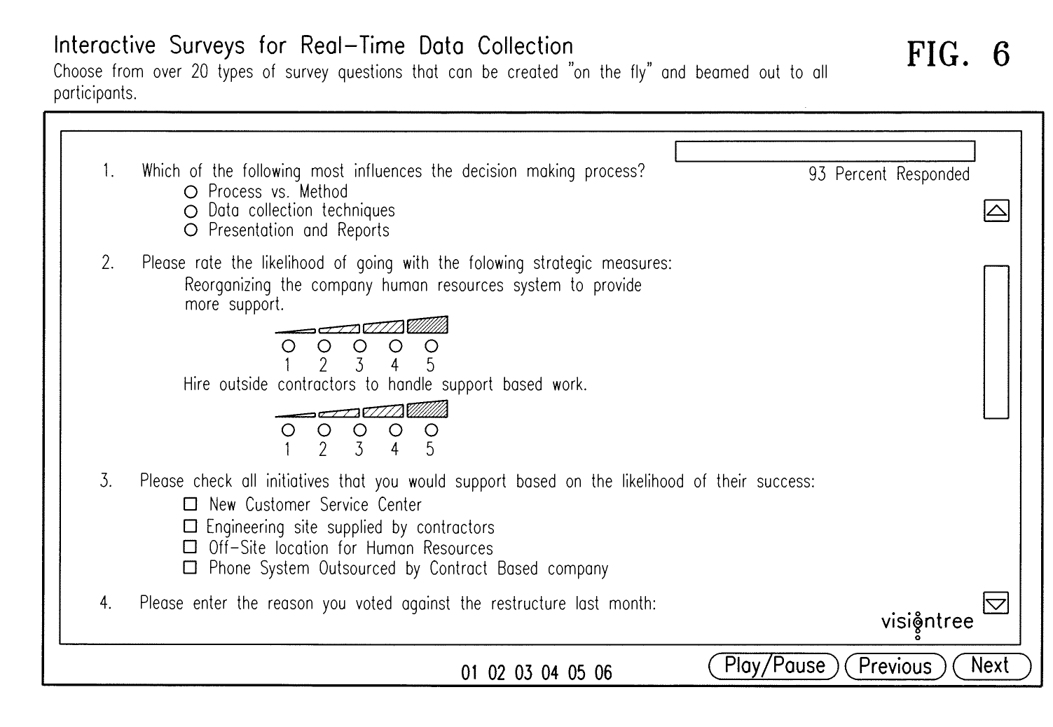

Multiple features are also provided to facilitate presenter/moderator interaction with the audience. In a “Reviewer Mode”, participant questions/comments can be filtered and/or edited by a moderator or technical assistant before being sent on to presenter 14. FIG. 6 is a screen shot of an exemplary “viewer's page”, showing a list of user questions and comments that may be reviewed and, if approved, sent onto the speaker for immediate debate and discussion. In “Speaker Mode”, the filtered questions/comments are sent on to the communication device of the speaker/moderator, who can then easily present the questions/comments for debate, open them to a panel, and so on. The presenter can also select questions/comments that are passed on to him for display on display 18. Questions may also be answered by the presenter after the session has ended in “Reply Mode”.

Real-time surveys and polls in multiple question types may be created and sent to participants 12 by system 40 to be answered during the course of the event., allowing relevant, actionable data to be gathered for immediate analysis and response. Graphical sliding scales, radio buttons, free form text, etc. are but some of the forms that survey questions may take. FIG. 6 is a screen shot showing exemplary survey questions sent from the presenter to participants.

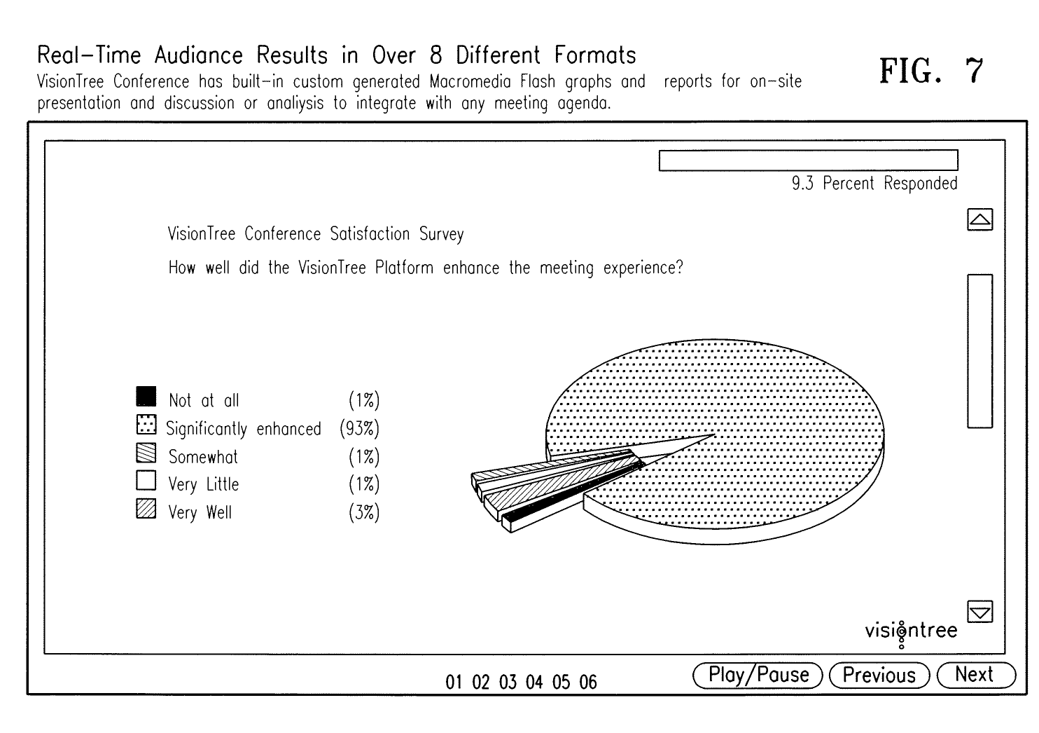

Simultaneous surveys may be provided, as well as surveys targeted by user profile. Surveys may be created “on-the-fly” using a dynamic survey builder. Data may be aggregated in real-time and presented to the audience in a variety of graphical formats, such as custom graphs and tables, for immediate analysis and group discussion. FIG. 7 is a screen shot showing an exemplary display of real-time audience results. Survey and poll data may be filtered by profile. Survey results, demographic data and audience viewpoints may be displayed. Individual and group test data may also be aggregated.

System 40 supports a dynamic agenda system as well as multiple languages. Remote use of system 40 may be provided to participants and presenters outside of the conference area via a designated IP address. A global messaging system may be implemented for conference updates. Thus, notification messages (i.e. lunch time, booth number, etc.) may be sent out to all or designated participants. A timer may be provided on the presenter's communication device to monitor presentation time, and a visual time indicator (i.e. red light) may be provided as well. Security functions such as user profile based login, password protected access and WEP/WAP 128-bit encryption are provided.

A pre-meeting website may be provided for agenda topics and creation, meeting materials, surveys, suggestions, etc. Similarly, a post-meeting website may present results of the conference, forum/Wiki style Q&A discussion, post presentations and materials, post-meeting surveys, event pictures as well as information regarding the next event.

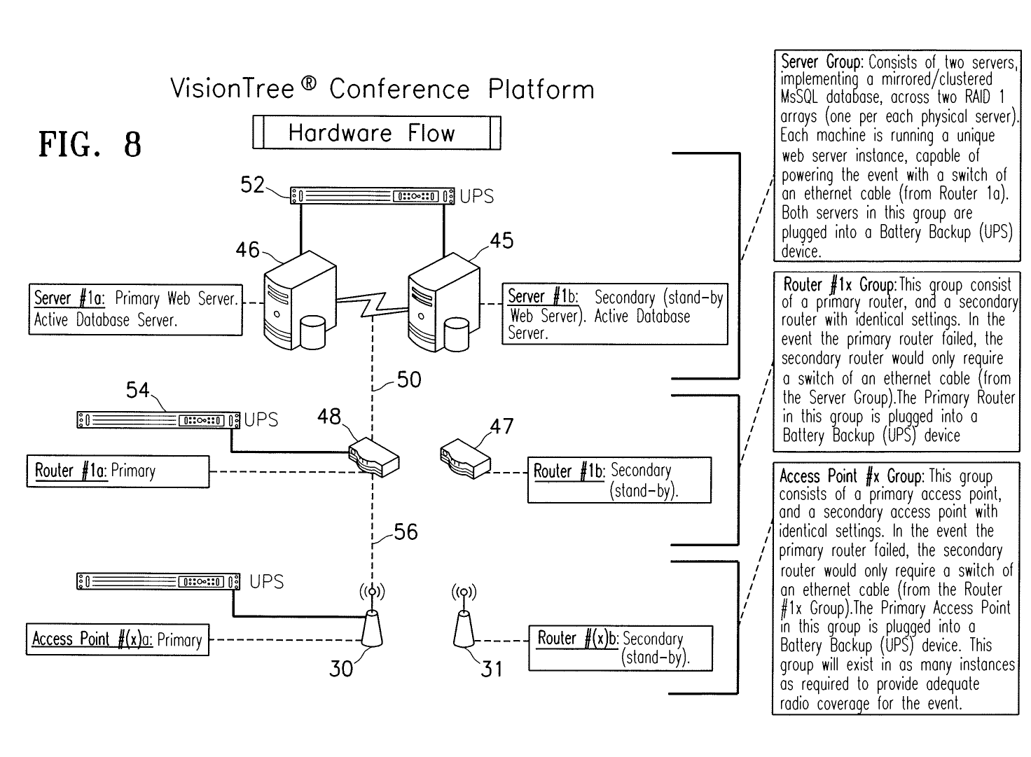

FIG. 8 is a block diagram showing the hardware components of system 40 in more detail. As shown in FIG. 8, each component of system 40 includes a backup component configured for easy substitution in the event of failure of one of the primary components. System 40 includes a primary web server 46, as illustrated in FIG. 8, and also includes a secondary or stand-by web server 45. A synchronized data flow is provided between servers 45 and 46. Thus, in the event that primary server 46 fails, stand-by server 45 is available and capable of powering the event with a simple switch of Ethernet cable 50 from primary server 46 to stand-by server 45.

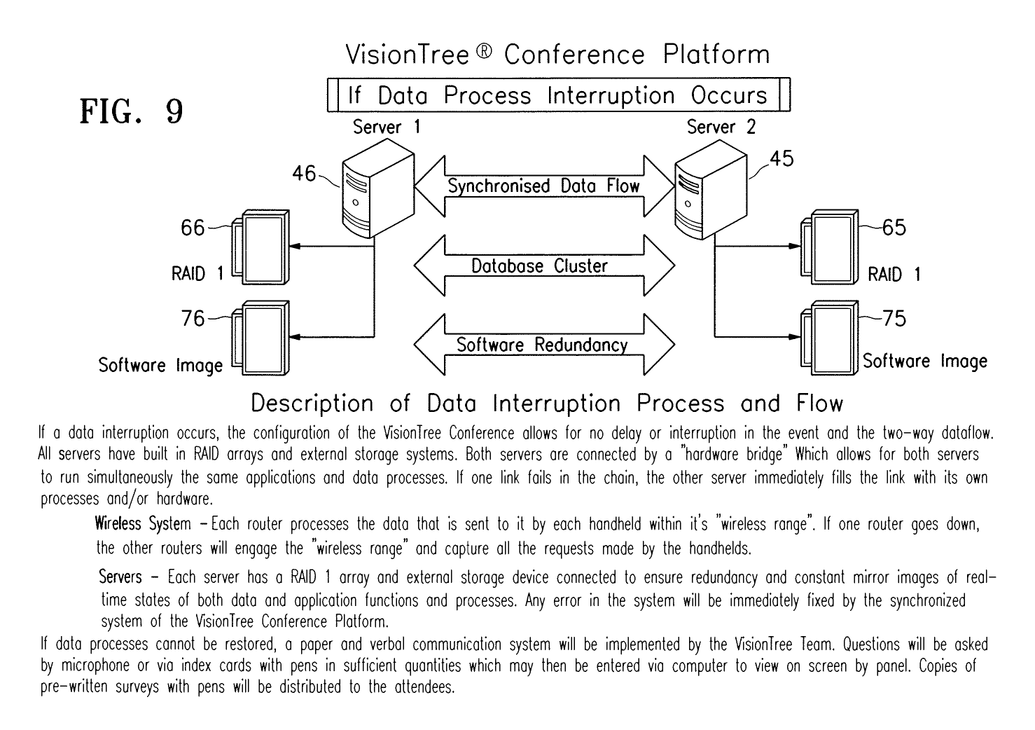

Servers 45 and 46 are each connected to a battery backup or uninterruptible power supply (UPS) device 52 to ensure consistent data flow and data capture into multiple data storage devices that can be quickly restored once electrical power has resumed. UPSs 52 ensure connectivity for a minimum of 45 minutes. In addition, as described in more detail with reference to FIG. 9, servers 45 and 46 are each connected to a RAID 1 array and external storage device to ensure redundancy and constant mirror images of real-time states of both data and application functions and processes. Once power has been restored the systems can be brought back online within 15 minutes.

System 40 also includes primary wireless router(s) 48 and secondary router(s) 47 with identical settings. In the event primary router 48 fails, secondary router 47 may be substituted by switching Ethernet cable 50 from router 48 to router 47. Router 48 is connected to UPS power supply 50 which ensures connectivity for a minimum of 45 minutes, which far exceeds the time required to transfer all data “in transit” from the handhelds to the server. Likewise, system 40 includes primary access point(s) 30 and secondary access point(s) 31. As many access points and backups are provided as necessary to provide adequate radio coverage for the event. In the event of failure of primary access point 30, Ethernet cable 56 connected to primary router 48 is merely switched from primary access point 30 to secondary access point 31.

If a data interruption occurs, system 40 allows for no delay or interruption in the event and two-way data flow. As depicted in FIG. 9, primary server 46 and backup server 45 each have built in RAID 1 arrays (66 and 65, respectively) and external storage (software imaging) systems (76 and 75, respectively). Servers 45 and 46 are connected by a hardware bridge 60 providing a synchronized data flow that allows both servers to run simultaneously the same applications and data processes. If one link in the chain fails, the other server immediately fills the link with its own processes and/or hardware.

The particular embodiments of the invention described in this document should be considered illustrative, rather than restrictive. Modification to the described embodiments may be made without departing from the spirit of the invention as defined by the following claims.

1. An audience participation system comprising:
a plurality of participant two-way communication devices;
at least one presenter two-way communication device; and
a central server and wireless LAN managing communications between the participant and presenter devices, wherein
the system provides real-time audience participation and real-time generation and display of results.

2. An audience participation system as claimed in claim 1, wherein the participant devices are selected from a group consisting of PDAs, laptops and cellphones.

3. An audience participation system as claimed in claim 1, wherein:
the participant devices comprise means for presenting surveys and questions, obtaining survey results and answers to the questions, and sending the survey results and answers to the presenter device; and
the presenter device comprises means for displaying the survey results and answers in real time.

4. An audience participation system as claimed in claim 1, wherein:
the participant devices comprise means for submitting real-time questions to the presenter device; and
the presenter device comprises means for answering the questions in real time, and means for collecting identification information of the participants and providing answers later.

5. An audience participation system as claimed in claim 1, wherein the participant and presenter devices comprise a dynamic event schedule.

6. An audience participation system as claimed in claim 1, wherein the participant and presenter devices comprise links to documents and media accessible in real time.

7. An audience participation system as claimed in claim 1, and further comprising means for tracking attendance at the event.

8. An audience participation system as claimed in claim 1, wherein the participant and presenter devices comprise a silent auction feature allowing the participants and presenters to bid on items in real time.

9. An audience participation system as claimed in claim 1, wherein the participant devices comprise an e-commerce application.

10. An audience participation system as claimed in claim 1, wherein the participant devices comprise:
a profile mode of operation, wherein participants login with identification information; and
an anonymous mode of operation, wherein participants participate anonymously.

11. An audience participation system as claimed in claim 1, wherein the presenter device comprises:
a reviewer mode of operation, wherein questions and comments from the participant devices are reviewed before being sent to the presenter device; and
a speaker mode of operation, wherein questions and comments are received and displayed by the presenter device.

12. An audience participation system as claimed in claim 1, and further comprising means for allowing remote use of the system by participants and presenters not present.

13. An audience participation system as claimed in claim 1, and further comprising a messaging system for sending messages to participant and presenter devices.

14. An audience participation system as claimed in claim 1, and further comprising a pre-event website for posting agenda topics and meeting materials.

15. An audience participation system as claimed in claim 1, and further comprising a post-event website for posting event results and information.

16. An audience participation system as claimed in claim 1, and further comprising a backup server having synchronized data flow with the central server, wherein the backup and central servers are connected to an uninterruptible power supply.

17. An audience participation system as claimed in claim 16, wherein the central and backup servers are each connected to a RAID 1 array and an external storage device to ensure redundancy and constant mirror images of both data and application functions and processes.

18. An audience participation system as claimed in claim 16, and further comprising primary and secondary wireless routers that are connected to an uninterruptible power supply.

19. An audience participation system comprising:
a plurality of participant two-way communication devices selected from a group consisting of PDAs, laptops and cellphones, the participant devices comprising:
means for displaying surveys and questions, collecting survey results and answers to the questions from participants, and communicating the survey results and answers; and
means for collecting questions from participants and communicating the collected questions;
at least one presenter two-way communication device comprising:
means for receiving the survey results and answers from the participant devices, and aggregating and displaying the results and answers in real time; and
means for receiving the questions from the participant devices and displaying the questions in real time; and
a central server and wireless LAN managing communications between the participant and presenter devices.

20. A method for facilitating participation in an event having a plurality of participants and a presenter comprising:
providing participant two-way communication devices that are custom-configured for the event;
providing a presenter two-way communication device that is custom-configured for the event;
sending questions and surveys to the participant devices;
obtaining and sending survey results and answers to the questions from the participant devices to the presenter device in real time;
obtaining and sending questions from the participant devices to the presenter device;
aggregating and displaying the answers and survey results in real time with the presenter device; and
displaying the questions from the participant devices in real time with the presenter device.
